(19) United States
(12) Patent Application Publication
(10) Pub. No.: US 2015/0058184 A1
(43) Pub. Date: Feb. 26, 2015

(54) System and Method for Identifying Taxable Events for Mobile Property

(71) Applicant: Synergy Aviation Services, Inc., Addison, TX (US)

(72) Inventor: Paul N. Clark, Addison, TX (US)

(73) Assignee: Synergy Aviation Services, Inc., Addison, TX (US)

(21) Appl. No.: 14/471,237

(22) Filed: Aug. 28, 2014

Related U.S. Application Data
(63) Continuation of application No. 14/465,619, filed on Aug. 21, 2014.
(60) Provisional application No. 61/868,333, filed on Aug. 21, 2013.

(51) Int. Cl. G06Q 40/00; G06Q 50/26

(52) U.S. Cl. CPC G06Q 40/12; G06Q 50/26
USPC 705/30

(57) ABSTRACT

A system and method for identifying taxable events for mobile assets such as aircraft is described. The system and method including a receiver capable of detecting mobile assets in the vicinity of a known location, wherein data about the mobile assets is collected by the receiver. A server, including a database, collects the data from the receiver and generates information about the history of the mobile assets. Information related to a tax status of the mobile asset is also accessed and the system determines if there has been a taxable event related to the mobile asset based on the asset history and tax status.

### CROSS REFERENCE TO RELATED INFORMATION

This application is a continuation of U.S. patent application Ser. No. 14/465,619, filed Aug. 21, 2014; which claims the benefit of U.S. Provisional Patent Application No. 61/868,333, filed Aug. 21, 2013, titled System and Method for Identifying Taxable Events for Mobile Property, the contents of which are hereby incorporated herein in its entirety.

### TECHNICAL FIELD

The present disclosure is directed to a system and method for identifying mobile taxable assets, and more particularly to tracking and establishing the tax status of mobile taxable assets such as airplanes.

### BACKGROUND OF THE INVENTION

Many taxing jurisdictions, such as county governments impose property taxes on their residents. For real property the assets are easy to identify, but many jurisdictions also impose some type of tax on personal property, vehicles or other movable assets such as airplanes and boats. It is much more difficult for the taxing jurisdiction to know whether those assets are subject to tax based on the amount of time that the asset is in the county during the taxable period. In many cases, such as with cars, airplanes and boats, the assets are registered in a low or no tax jurisdictions, but may actually spend the majority of their time in a taxable jurisdiction. Some jurisdictions will occasionally send agents to airports and lakes to make note of registration numbers, however this does not establish patterns or sufficiency of duration for taxing purposes.

In addition to property taxes there are several other kinds of taxes and fees that are problematic for mobile property. Transaction or sales taxes can be difficult to assess on mobile property if the new owner declares their intention to take the property out of the jurisdiction within a short time after the sale. The jurisdiction entitled to collect the tax may never become aware that the property was brought into the jurisdiction after the transaction.

Usage fees can also be difficult to track and assess. Many airports, for example, charge usage fees for aircraft taking off or landing at the facility. Unless there is a dedicated person watching all take offs and landings, the facility may not collect all of the fees owed to it.

What is needed is a system and method for tracking the movements of mobile property using existing infrastructure, so that taxing jurisdictions can properly evaluate and apply taxable events to the owners of mobile property.

### BRIEF SUMMARY OF THE INVENTION

In a preferred embodiment, a system for identifying taxable events for mobile assets is described. The system includes a receiver capable of detecting mobile assets in the vicinity of a known location and collecting data about the mobile assets. A server, including a database, receives the data from the receiver and generates information about the history of the mobile assets. The server and database also contain information related to a tax status of the mobile asset. A report generation tool determines if there has been a taxable event related to the mobile asset based on information from the database and the data from the receiver.

In another preferred embodiment, a method for identifying taxable events for mobile assets is described. The method includes selecting criteria related to a taxable event for mobile assets in a particular jurisdiction, and collecting information on the mobile assets related to the selected criteria. The method then queries an asset information database using the criteria, the asset information database returning particular mobile assets meeting the criteria and supporting information and generates a target list of assets meeting the criteria. The method then determines if the appropriate tax has been paid for each asset on the target list.

In yet another preferred embodiment a method for identifying whether appropriate property taxes have been paid for a particular aircraft is described. The method includes collecting data on aircraft take-offs and landings at a selected airport and generating a target list of aircraft based on the take-off and landing data. The method then determines whether aircraft on the target list is on a property tax roll for a taxing jurisdiction that includes the selected airport and generates a case file for each aircraft on the target list that is not on the property tax roll.

In yet another preferred embodiment, a system for identifying whether appropriate property taxes have been paid for a particular aircraft is described. The system including a data source providing data on aircraft take-offs and landings at a selected airport and a server and associated database receiving data from the data source and generating a target list of aircraft based on the take-off and landing data. The server further determines whether aircraft on the target list is on a property tax roll for a taxing jurisdiction that includes the selected airport, and generates a case file for each aircraft on the target list that is not on the property tax roll.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a system diagram of an embodiment of a system for identifying and tracking taxable mobile assets;

FIG. 2 is a functional block diagram of an embodiment of a system for identifying and tracking taxable mobile assets according to the concepts described herein;

FIG. 3 is a block diagram of an embodiment of an aircraft information database system according to the concepts described herein;

FIG. 4 is a block diagram of an embodiment of an aircraft valuation/transactional database system according to the concepts described herein;

FIGS. 5A-5D are examples of screen shots from an embodiment of a system according to the concepts described herein; and

FIG. 6 is a block diagram of an embodiment of a computer/server usable with the system described herein.

### DESCRIPTION OF THE INVENTION

Mobile assets, such as airplanes, recreational vehicles, boats and the like, can cause great difficulties for taxing authorities. In many instances taxes are due in the jurisdiction where the mobile property is based. However, the taxing authority must usually rely on the mobile asset owner declaring to the jurisdiction that it is based there. As a result, many owners of mobile assets declare that the asset is based in a jurisdiction with low or no tax rates on those types of assets. Those assets, however, are often in reality based in other jurisdictions with a higher tax rate. For example, an aircraft may be declared to be based out of an airport in a county in New Mexico with no personal property taxes, while in reality, the aircraft spends the vast majority of its time at an airport that would subject it to a much higher tax, such as Love Field in Dallas, Tex. Similarly, an aircraft purchased in Montana, may be quickly moved to California or New York. Since the aircraft is moved from Montana immediately after the purchase Montana does not collect taxes on the transaction, however, California may not be aware that the aircraft was just purchased and may fail to collect the sales taxes that would otherwise be due.

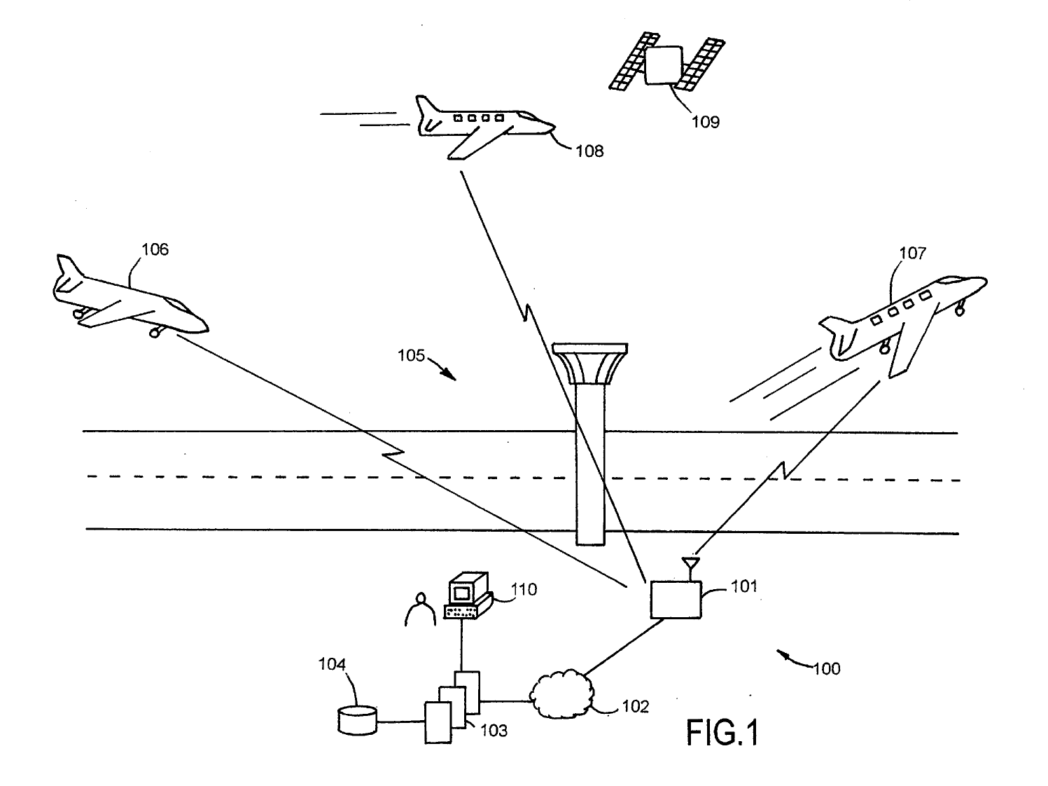

Referring now to FIG. 1, an embodiment of a system for collecting information about mobile objects, such as aircraft, is shown. System 100 uses a data collection device, such as an Automatic Dependent Surveillance-Broadcast (ADSB) receiver 101, to collect identifying information broadcast by aircraft. The receiver 101 can detect aircraft landing at or taking off from a known airport 105, such as aircraft 106 and 107, respectively. The receiver 101 can also detect aircraft passing through the area, such as aircraft 108. Receiver 101 may use GPS from satellites 109 to determine its location or may have a fixed location programmed into the device at the time of installation. The receiver can preprocess the information or can send the raw data over the Internet or other network 102 to servers 103. The information is then stored in database 104 and analyzed by servers 103. Users can access the data in database 104 and servers 103 using a computer or terminal 110 connected directly to servers 103 or using a portal or other network connection.

Using this information from ADSB receiver 101, and from other receivers, FAA flight data information and other data sources, servers 103 can be used to detect aircraft that trigger tax status at a particular airport or taxing jurisdiction. The system can also be used to determine usage fees, such as landing fees at a particular airport. While receiver 101 is described with respect to aircraft, other types of technology can be used for other types of mobile assets. Receivers with cameras can be used with text recognition to identify registration numbers on boats or license plates on RVs, trucks or other vehicles.

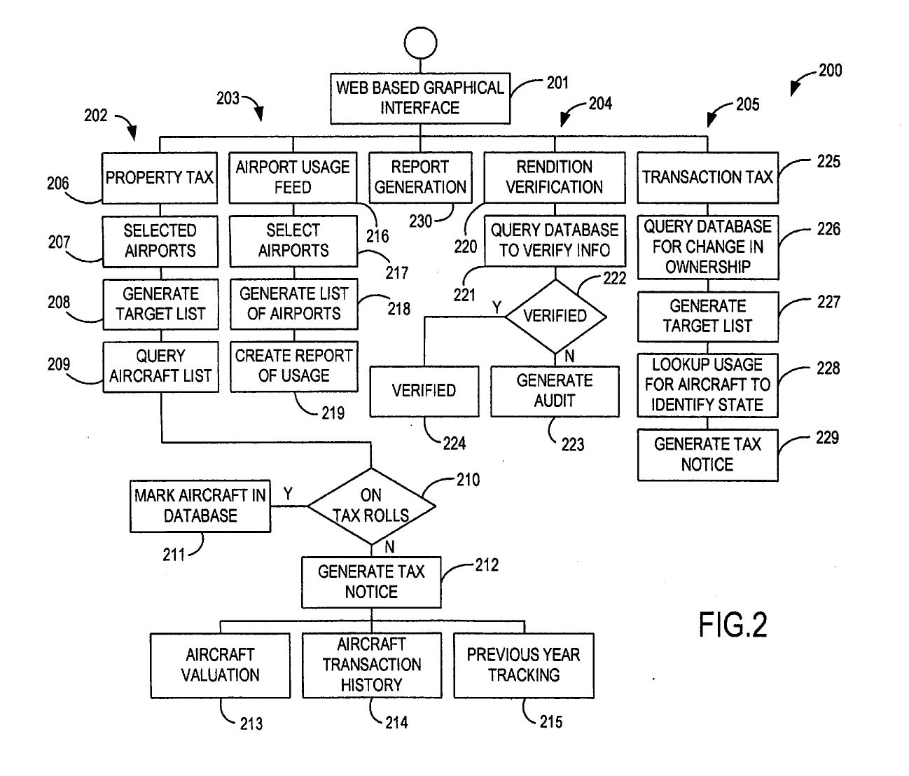

Referring now to FIG. 2, an embodiment of a system 200 and method for allowing taxing jurisdictions to identify, assess and value potential taxable assets and transactions using available databases is shown. The system can be either a standalone program running on a computer or server, or more preferably, is a web based service accessible to users through a standard browser interface, such as is shown in FIG. 1 with servers 103 and user computer 110 using interface 201. The system 200 can include multiple sub-functions such as property tax identification 202, usage fee identification 203, rendition verification 204, and transaction tax identification 205. A report generation function 230 allows the system to produce reports for each type of sub-function as well as other types of reports or custom reports that draw information from multiple sub-functions. Other types of sub-functions that could make use of the data and the infrastructure described herein can also be added without departing from the scope of the concepts described herein. Again, while FIG. 2 makes reference specifically to aircraft, one skilled in the art will recognize the applicability of the system and infrastructure to all types of mobile assets and the same or similar processes could be employed for those assets as well as aircraft.

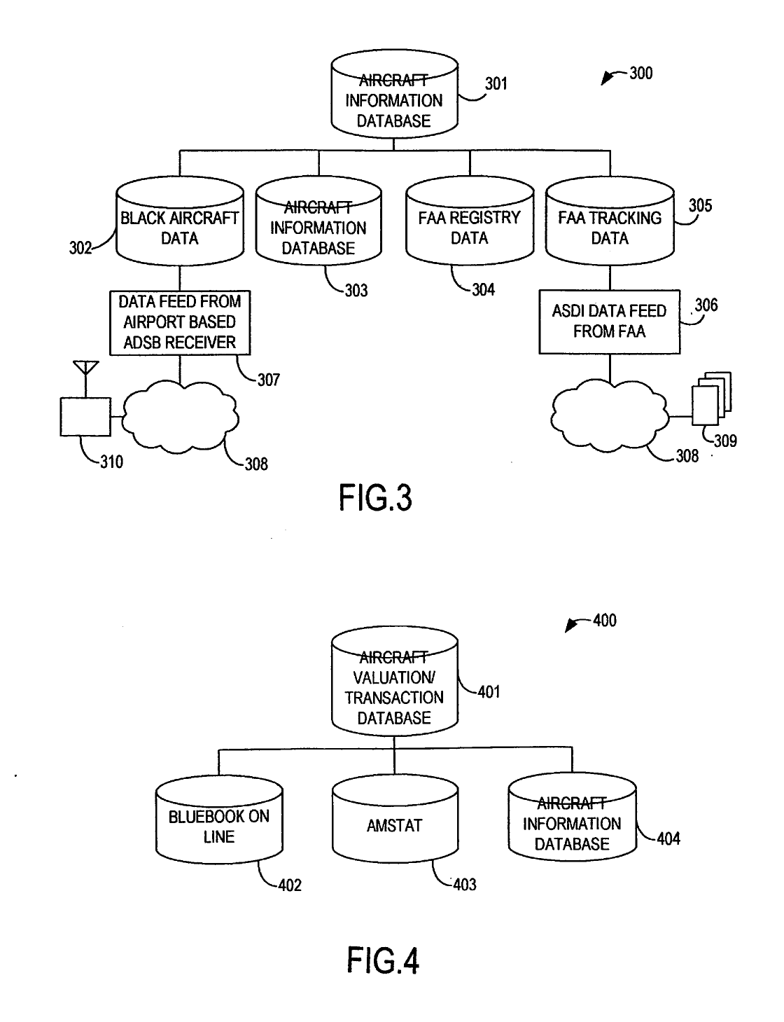

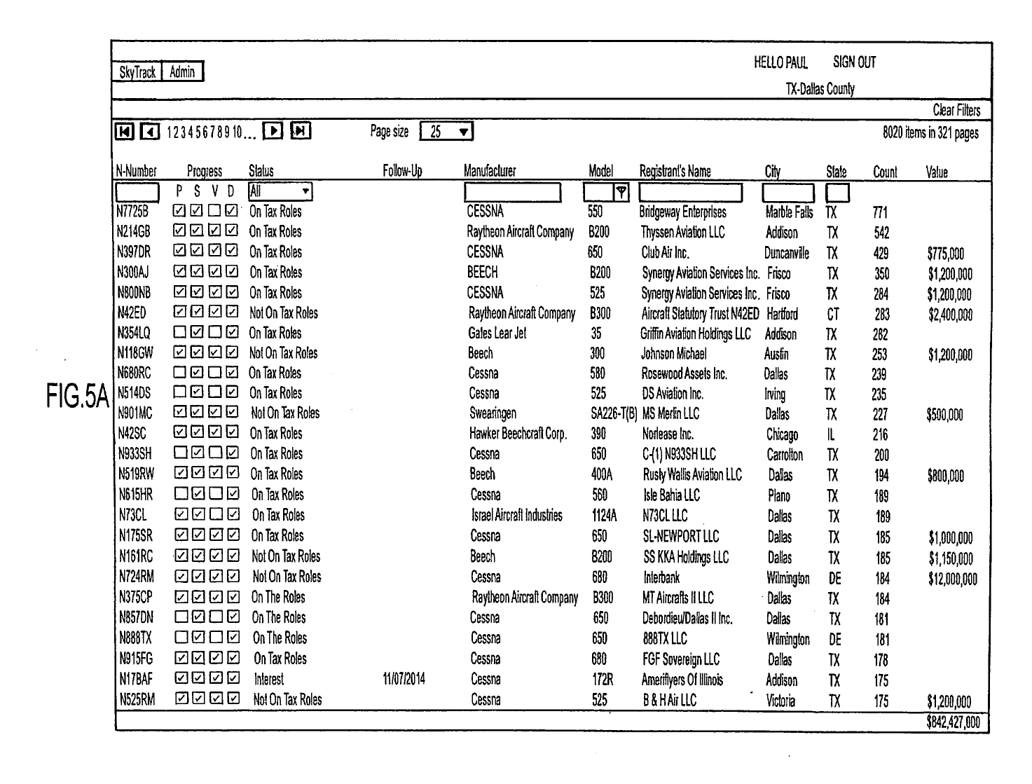

A preferred embodiment of the property tax sub-function 202 is shown with respect to property tax function 206. Identification of assets subject to property tax can be done on a jurisdiction by jurisdiction basis. In the case of aircraft, the process usually begins by the selection of an airport or airports in the taxing jurisdiction, as is shown by function 207. A target list is generated in function 208 by looking at the take-off and landing detail for individual aircraft at that airport. The target list can be generated using FAA flight plan data from an FAA data feed or can be gathered using an ADSB receiver to record aircraft arriving at or leaving the airport, or can be gathered from other flight tracking systems, databases or any combination thereof. After a target list has been generated, an aircraft information database is queried to pull information related to the target aircraft on the list, as shown in function 209. The aircraft information database, as will be discussed in more detail with respect to FIG. 3, is a database pulling disparate data from multiple sources and relating the data is a way usable by the system.

Once the aircraft database information has been pulled for a particular aircraft, the system determines whether the aircraft is on the tax rolls in the jurisdiction of interest, as shown by function 210. This step is only done for those aircraft that meet the criteria for the tax rolls. If one of the target aircraft is determined not to meet the relevant criteria for the taxing authority is can be dropped from the target list. If the aircraft is on the tax rolls, function 211 marks the aircraft in the database as properly categorized. If the aircraft is not on the tax rolls, function 210 generates a case file and pulls relevant information on the aircraft for inclusion in the case file. The relevant information can include aircraft valuation 213, aircraft transaction history 214, prior year tracking records 215 for one or more years, and any other information relevant to the aircraft or requested by the taxing authority.

A preferred embodiment of the usage fee function 203 is shown with respect to airport usage fee function 216. Once airports of interest are selected in function 217, a database, such as the aircraft information database, is queried to determine aircraft that have used the airport or airports of interest, as shown in function 218. Once the list of relevant aircraft has been compiled, function 219 creates a usage report for each aircraft and each selected airport. This report can then be used by the relevant authority to make sure all of the incurred usage fees have been paid or where the usage fees are deficient, can allow the fee collection authority to send a bill or invoice for the missing fees.

A preferred embodiment of the rendition verification function 204 is shown by function 220. Many jurisdictions require a rendition of taxable property where each property owner must self report information about their taxable property, such as condition, usage, valuation etc. In many cases the taxing jurisdiction has no mechanism to validate the information in the form reported by the asset owner. The system 200 described herein can use its data sources to fully or partially verify the information in most renditions of taxable property. Function 221 shows a query to the relevant databases in the system to verify the information provided in the rendition. If the information is verified by function 222, the rendition is confirmed, as shown by function 224. If there are discrepancies between the information supplied by the asset owner and the database, then an audit request or recommendation can be generated and sent to the taxing authority. The taxing authority can then follow up with the asset owner to determine which information is correct.

A preferred embodiment of a function 205 for determining transactional or sales taxes is shown in transaction tax function 225. Function 226 queries the appropriate databases for changes in ownership of registered aircraft. A target list of aircraft that have changed ownership is generated by function 227. Usage information is retrieved for aircraft on the target list by function 228. The usage information allows the system to determine the taxing authority that should be due the transactional or sales tax on the aircraft from the ownership change. A tax notice can then be generated by function 229. The tax notice can be used to verify the payment of the appropriate taxes or to send to the new owner to indicate that the tax is due.

Each of the functions described with respect to FIG. 2 may reference a property, or aircraft, database 301. An embodiment of that aircraft information database 301, and the database system 300, is shown in FIG. 3. The aircraft database 301 can be a repository of data or can pull data in real time from the underlying databases. For the purposes of the embodiments of the function shown in FIG. 2, the database is in communication with other public and private databases. These databases can include county, state, or city property records 303 which can provide tax and ownership information for the assets. The FAA registry database 304 provides current ownership information for aircraft. The FAA tracking data 305 through the ASDI feed 306, which may use the Internet 308 to transmit data from remote sources 309 provides information on take-offs and landings through flight plans filed with the FAA. The block aircraft data 302 information provides real-time and historical tracking information through a shared or private ADSB infrastructure 307. A private infrastructure may include a receiver 310 that communicates over Internet 308, as was further described with reference to FIG. 1.

The Aircraft Situation Display to Industry (ASDI) data stream is a service of the U.S. Department of Transportation that shows the position and flight plans of aircraft in the U.S. operating on IFR flight plans. The data stream reports the take offs and landings at all airports as reported in the flight plans filed with the Department of Transportation. Using information from the ASDI the movement of all commercial and private aircraft flying under flight plans can be tracked. As described above, the Automatic Dependent Surveillance-Broadcast (ADSB) is a surveillance technology for tracking aircraft. Equipment aboard each aircraft periodically broadcasts information about the aircraft to receivers on the ground. Those receivers are networked and provide a global picture to air traffic control of all the aircraft in the air at any time. A feed from a receiver at an airport would provide information for all aircraft taking off and landing at that airport.

Using the data from each of these sources, a database can be constructed that would allow taxing authorities to identify taxable transactions and properties that are within the taxing jurisdiction. Returning to FIG. 2, the system and method uses this information in each of the different types of circumstances of interest to taxing jurisdictions. For the identification of mobile assets subject to property taxes, as is common at the county level, the system determines those aircraft that have, based on takeoff and landing histories from the FAA tracking database or Block Aircraft Database, spent enough time in the county to be considered taxable assets in the county. It may be necessary to get owner information from the FAA registry database to search the county tax rolls, as the aircraft data itself may not appear in the tax rolls.

With regard to transaction, or sales taxes, there currently isn't a system that tracks where that aircraft ends up and only self reporting by the owner would result in the appropriate transaction taxes being paid. The system described herein is able to query the aircraft identification database to identify aircraft that have recently changed owners based on the FAA registry database. For usage fees, the flight history for a particular airport can be used. The aircraft information database can generate a list of all takeoffs and landings at the airport and create a report of usage and also generate fee statements for the aircraft that used the airport in the reporting period.

While an embodiment of the system and method have been described using aircraft as the mobile asset, the system and method can be used to generate similar reports and information about other types of mobile assets using similar public and private databases associated with those types of assets, such as boats, RVs, and other vehicles.

Referring now to FIG. 3 where it is useful or necessary to know the aircraft's valuation an embodiment of a system 400 of determining and storing aircraft valuation information is shown which includes aircraft valuation database 401. As with the system 300 from FIG. 3, the data can be pulled from sources in real-time as needed, can be periodically downloaded on a preset schedule, or can be retrieved by other mechanisms without departing from the scope of the concepts described herein. The system can be used to estimate the aircraft's value using valuation database 401. The valuation database 401 can pull valuation information from sources such as industry standard valuation data resources 402 and 403 and can pull operational information 404 that might affect the aircraft's value. From these sources an estimated value can be determined that would help determine the potential tax associated with the aircraft.

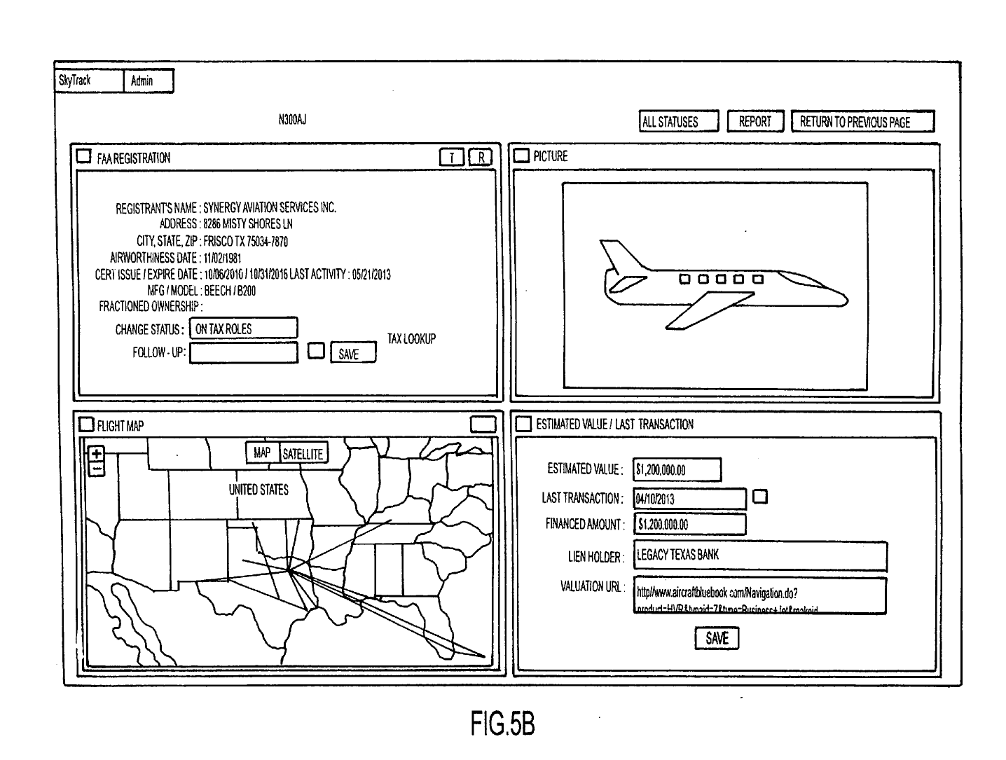

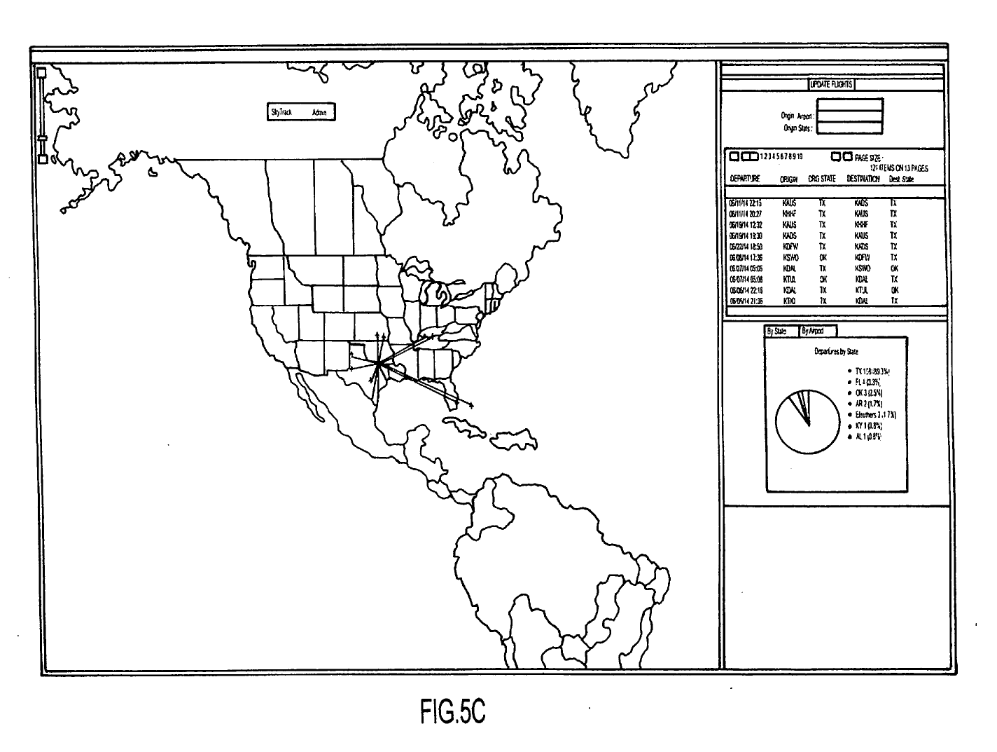

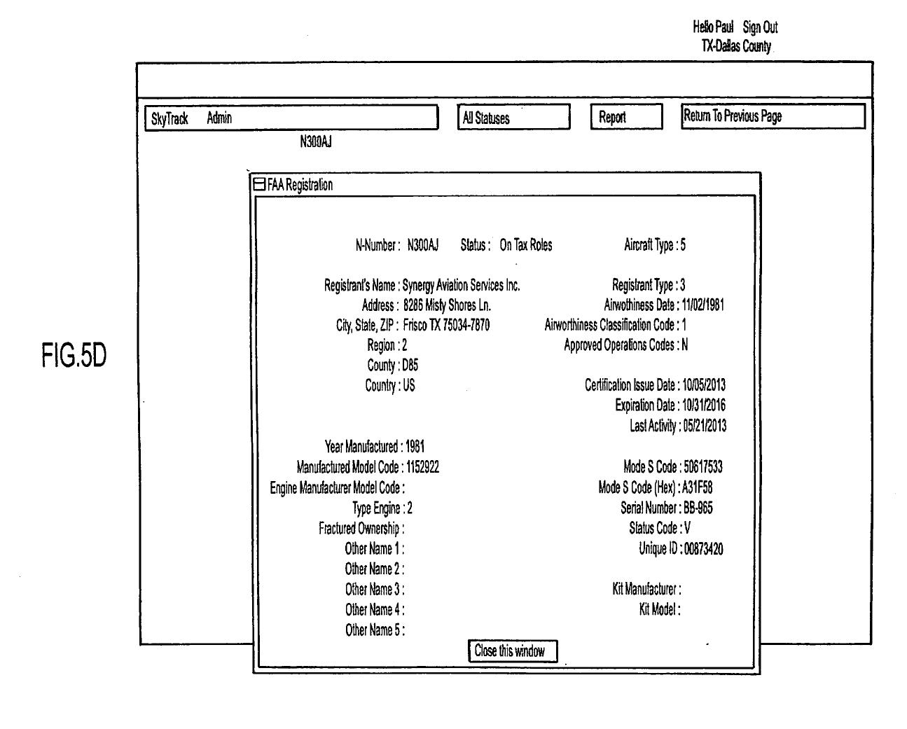

FIGS. 5A through 5D are examples of embodiments of screen shots generated by a system and method according to the concepts described herein. FIG. 5A showns an example of a target list generated as described herein. The target list shows information on various aircraft, or other property, that meet search criteria, such as take offs and landings at a particular airport. FIG. 5B is a screen shot of a drill down on a particular aircraft from the target list. The additional information can include registration information, a photograph of the airplane in question or the same model aircraft, an estimated value for the aircraft and a flight map. FIG. 5C is a screen shot showing a more detailed flight map with information on times and dates and airports. FIG. 5D is a screen shot showing more detail on the aircraft's registration information.

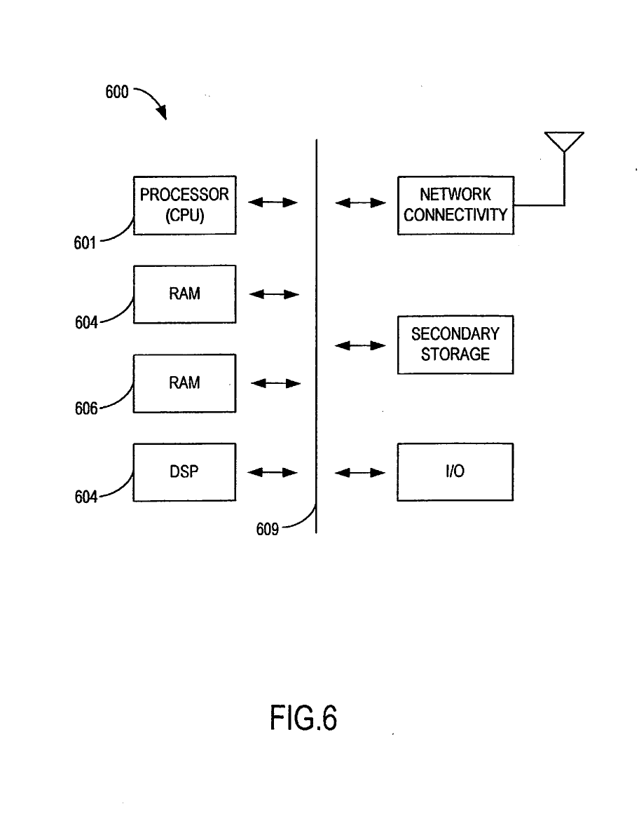

FIG. 6 illustrates an example of a system 600 that includes a processor 601 or multiple processors suitable for implementing one or more embodiments disclosed herein. The processor(s) 601 may control the overall operation of the device or system.

In addition to the processor 601 (which may be referred to as a central processor unit or CPU), the system 600 might include network connectivity devices 602, random access memory (RAM) 604, read only memory (ROM) 606, secondary storage 605, and input/output (I/O) devices 608. These components might communicate with one another via a bus 609. In some cases, some of these components may not be present or may be combined in various combinations with one another or with other components not shown. These components might be located in a single physical entity or in more than one physical entity. Any actions described herein as being taken by the processor 601 might be taken by the processor 601 alone or by the processor 601 in conjunction with one or more components shown or not shown in the drawing, such as a digital signal processor (DSP) 607. Although the DSP 607 is shown as a separate component, the DSP 607 might be incorporated into the processor 601.

The processor 601 executes instructions, codes, computer programs, or scripts that it might access from the network connectivity devices 602, RAM 604, ROM 606, or secondary storage 605 (which might include various disk-based systems such as hard disk, floppy disk, or optical disk). While only one CPU 601 is shown, multiple processors may be present. Thus, while instructions may be discussed as being executed by a processor, the instructions may be executed simultaneously, serially, or otherwise by one or multiple processors. The processor 601 may be implemented as one or more CPU chips and may be a hardware device capable of executing computer instructions.

The network connectivity devices 602 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, universal mobile telecommunications system (UMTS) radio transceiver devices, long term evolution (LTE) radio transceiver devices, worldwide interoperability for microwave access (WiMAX) devices, and/or other well-known devices for connecting to networks. These network connectivity devices 602 may enable the processor 601 to communicate with the Internet or one or more telecommunications networks or other networks from which the processor 601 might receive information or to which the processor 601 might output information. The network connectivity devices 602 might also include one or more transceiver components 603 capable of transmitting and/or receiving data wirelessly.

The RAM 604 might be used to store volatile data and perhaps to store instructions that are executed by the processor 601. The ROM 606 is a non-volatile memory device that typically has a smaller memory capacity than the memory capacity of the secondary storage 605. ROM 606 might be used to store instructions and perhaps data that are read during execution of the instructions. Access to both RAM 604 and ROM 606 is typically faster than to secondary storage 605. The secondary storage 605 is typically comprised of one or more disk drives or tape drives and might be used for non-volatile storage of data or as an over-flow data storage device if RAM 604 is not large enough to hold all working data. Secondary storage 605 may be used to store programs that are loaded into RAM 604 when such programs are selected for execution.

The I/O devices 608 may include liquid crystal displays (LCDs), touch screen displays, keyboards, keypads, switches, dials, mice, track balls, voice recognizers, card readers, paper tape readers, printers, video monitors, or other well-known input/output devices. Also, the transceiver 603 might be considered to be a component of the I/O devices 608 instead of or in addition to being a component of the network connectivity devices 602.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for identifying taxable events for mobile assets comprising:
a receiver capable of detecting mobile assets in the vicinity of a known location, wherein data about the mobile assets is collected by the receiver;
a server, including a database, collecting the data from the receiver and generating information about the history of the mobile assets and also containing information related to a tax status of the mobile asset;
a report generation tool operable to determine if there has been a taxable event related to the mobile asset based on information from the database and the data from the receiver.

2. The system of claim 1, wherein taxable events include property taxes, usage fees, and sales taxes.

3. The system of claim 1, wherein the database is an asset information database including information on property records, registry data, and asset tracking data.

4. The system of claim 1, further comprising a valuation database, the valuation database including information related to the value of the mobile asset.

5. The system of claim 4, wherein the valuation database includes data on mobile asset value and operation information.

6. The system of claim 1, wherein the mobile assets are aircraft.

7. The system of claim 6, wherein the receiver is an Automatic Dependent Surveillance-Broadcast (ADSB) receiver.

8. The system of claim 6, wherein the database is an aircraft information database including information on Federal Aviation Administration (FAA) registry data, FAA flight tracking data, and county property tax data.

9. The system of claim 1, further comprising a rendition verification function.

10. A method for identifying taxable events for mobile assets comprising:
selecting criteria related to a taxable event for mobile assets in a particular jurisdiction;
collecting information on the mobile assets related to the selected criteria;
querying an asset information database using the criteria, the asset information database returning particular mobile assets meeting the criteria and supporting information;
generating a target list of assets meeting the criteria; and
determining if the appropriate tax has been paid for each asset on the target list.

11. The method of claim 10, wherein the taxable event include property taxes, usage fees, and sales taxes.

12. The method of claim 10, wherein the asset information database includes information on property records, registry data, and asset tracking data.

13. The method of claim 10, further comprising a valuation database, the valuation database including information related to the value of the mobile asset.

14. The method of claim 1, wherein the mobile assets are aircraft.

15. The method of claim 14, wherein the asset information database is an aircraft information database including information on Federal Aviation Administration (FAA) registry data, FAA flight tracking data, and county property tax data.

16. The method of claim 10, further comprising a rendition verification function.

17. A method for identifying whether appropriate property taxes have been paid for a particular aircraft, the method comprising:
collecting data on aircraft take-offs and landings at a selected airport;
generating a target list of aircraft based on the take-off and landing data;
determining whether aircraft on the target list is on a property tax roll for a taxing jurisdiction that includes the selected airport; and
generating a case file for each aircraft on the target list that is not on the property tax roll.

18. The method of claim 17, wherein the collected data is stored in an aircraft information database that also includes information on Federal Aviation Administration (FAA) registry data, FAA flight tracking data, and county property tax data.

19. The method of claim 17, further comprising a rendition verification function.

20. The method of claim 17 further comprising using the collected data on aircraft take-offs and landings to determine airport usage fees.

21. The method of claim 18 further comprising using the collected data on aircraft take-offs and landings and FAA registry data to determine aircraft sales taxes.

22. A system for identifying whether appropriate property taxes have been paid for a particular aircraft, the system comprising:
a data source providing data on aircraft take-offs and landings at a selected airport;
a server and associated database receiving data from the data source and generating a target list of aircraft based on the take-off and landing data, the server further determining whether aircraft on the target list is on a property tax roll for a taxing jurisdiction that includes the selected airport, and generating a case file for each aircraft on the target list that is not on the property tax roll.

23. The system of claim 22, wherein the collected data is stored in an aircraft information database that also includes information on Federal Aviation Administration (FAA) registry data, FAA flight tracking data, and county property tax data.

24. The system of claim 22, further comprising a rendition verification function.

25. The system of claim 22 further comprising an airport usage fee function using the collected data on aircraft take-offs and landings.

26. The method of claim 22 further comprising an aircraft sales tax function using the collected data on aircraft take-offs and landings and FAA registry data.
